(19) United States
(12) Patent Application Publication
(10) Pub. No.: US 2020/0088117 A1
(43) Pub. Date: Mar. 19, 2020

(54) Variable Compression Ratio Engine by Hydraulic-Mechanical Mechansim

(71) Applicant: Ali Abed-Ali ElZein, Dearborn Heights, MI (US)

(72) Inventor: Ali Abed-Ali ElZein, Dearborn Heights, MI (US)

(21) Appl. No.: 16/532,849

(22) Filed: Aug. 6, 2019

Related U.S. Application Data
(60) Provisional application No. 62/732,286, filed on Sep. 17, 2018.

(51) Int. Cl. F02D 15/04; F02B 75/04

(52) U.S. Cl. CPC F02D 15/04; F02B 75/044

(57) ABSTRACT

Variable compression ratio (VCR) in reciprocating internal combustion engine must be achieved in very short time or in less than 10 degrees from TDC. To accomplish this a closed-circuit system of hydraulic cylinder pump-follower driven by End-Cam, centered on the crankshaft journal, and a hydraulic jack linked to a mechanical scissor jack. This arrangement speeds up the VCR action while reduces pressure load on the VCR mechanism and allows for higher compression ratio. The rotation of the End-Cam with respect to the hydraulic cylinder pump engages the plunger-follower with the Cam rise/lift at TDC. Then starts pumping oil to the hydraulic jack that is linked to the scissor jack and lift/push up the engine piston. Addition of an actuator to the End-Cam advances or delays VCR action. This hydraulic-mechanical system is compact is size with options for various mechanical linkages and customizable in different ways that two configurations are presented.

### CROSS REFERENCE TO RELATED APPLICATION

This application claims the benefit of and takes priority from U.S. Provisional Application Ser. No. 62/732,286 filed on Sep. 17, 2018, the contents of which are herein incorporated by reference.

### BACKGROUND OF THE INVENTION

### Field of the Invention

The present invention generally relates to a reciprocating internal combustion engine with a variable compression ratio using hydraulic-mechanical mechanism capable of shifting-up the TDC position towards the head cylinder, hence reduces clearance volume and increases the compression ratio of the engine.

### Description of the Related Art

Variable compression ratio technique aims to increase the pressure in gasoline engines in order to increase efficiency, power and save fuel consumption. VCR aims to mimic diesel engines where compression ratio is more than 15:1 atm. while in gasoline engine its maximum is 10:1 atm. VCR mechanism should be achieved when the engine piston reaches its TDC (top dead center) travel of compression stroke to avoid knocking effect, since gasoline is very volatile compared to diesel fuel.

Automotive companies and inventors have different approaches. Almost none has really achieved VCR, especially at low engine rotations per minute (rpm) and still uses spark plugs. Most, mechanical, mechanisms take long time to lift/push up the engine piston few millimeters further into the clearance volume just after TDC compression stroke. Here there is competition between the VCR mechanism trying to push-up piston further and the crankshaft rotation pulling-down the piston from TDC to BDC (bottom dead center). Other, hydraulic, mechanisms do not have enough power to drive-up the piston due to the compressed air pressure in clearance volume above piston. They rely on the engine oiling/lubricating hydraulic pump that operates in “open circuit” while lubricating moving parts of the engine.

The presented invention, related to reciprocating internal combustion engine, uses hydraulic-mechanical mechanism in a “closed circuit”. The combined mechanisms for VCR engine are capable of driving/lifting/pushing up the engine piston into the clearance volume from TDC in very short time while experiencing less pressure load. The present invention affords different mechanisms with and without actuator that can be used to advance or delay the VCR action. However, the principle is same for all, a closed circuit hydraulic-mechanical system.

### SUMMARY OF THE INVENTION

This invention for reciprocating VCR engine has two configurations that are essentially based on a hydraulic cylinder pump (HCP) and a hydraulic jack (HJ) in a closed circuit separated from the engine oiling hydraulic pump. Both HCP and HJ can be part of the conrod (FIGS. 1 and 2) or part of the crankshaft web (FIG. 6). The plunger of the HCP forms the follower driven by a fixed or a variable rotation End-Cam. The hydraulic jack (HJ) is linked to any type of mechanical mechanisms to drive/lift/push-up the engine piston in order to achieve VCR. There are different mechanical links, each has advantages and disadvantages, that are customizable to meet the manufacturer needs.

In this invention the angular rotation it takes to achieve VCR is less than 10 degrees from TDC (usually marked 0 degree) where the effect of crankshaft rotation on pulling-down the engine piston is marginal. However, the angular rotation range depends on the CAM-follower lifting dimensions which in turn depends on the, customizable, stroke and area of the HCP. Also adding an actuator to a variable rotation End-Cam the VCR action is advanced/delayed so decreases/increases VCR rotation range, after TDC, in order to meet the best conditions for engine performance.

In general, this invention is customizable in many ways: the configuration of the hydraulic system and linkage, with/without actuator, the lifting dimensions of the CAM-follower. Besides, this invention suits both gasoline and diesel fuels.

### BRIEF DESCRIPTION OF THE DRAWINGS

FIGS. 1-a and 1-b the first configuration of the hydraulic-mechanical VCR, seen along the rod journal axis, presents the piston at TDC position (1-a) and the piston lifted up by VCR action (1-b) after the crank rotates 9 degrees. The list of parts are:

| 1) | VCR lift (L_{vcr}) | | |
|---|---|---|---|
| 2) | Small conrod eye | | |
| 3) | Oil passage | | |
| 4) | Conrod | | |
| 5) | Hydraulic and scissor jack coupler | | |
| 6) | Scissor jack arm (L_{scr}), | 6a) | conrod pivot for scissor jack, |
| 6b) | coupler pivot for scissor jack, | 6c) | big-eye pivot for scissor jack |

| | |
|---|---|
| 7) | front and rear hydraulic jack housings |
| 8) | Hydraulic jack piston and ram |
| 9) | Conrod guide |
| 10) | Plunger and roller of the rise hydraulic cylinder pump |
| 11) | End-Cam rise stroke (R_{S} in FIG. 3-b) |
| 12) | End-Cam rise dwell |
| 13) | End-Cam return dwell |
| 14) | End-Cam disk |
| 15) | Oil feed to hydraulic cylinder pumps with valve and spring |
| 16) | End-Cam short cylinder |
| 17) | End-Cam hydraulic actuator vane and spring |
| 18) | Rod journal outline |
| 19) | Plunger and roller of return hydraulic cylinder pump |
| 20) | End-Cam return stroke (T_{S} in FIG. 3-b) |
| 21) | Main journal outline |
| 22) | Hydraulic jack orifice with valve to vent air and to prevent Oil |
| | back drain |
| 23) | Rise stroke oil passage |
| 24) | Return stroke oil passage |
| 25) | Conrod big eye bolts |
| 26) | End-Cam outlines |
| 27) | Plungers/rollers linear guide |
| 28) | Crank rotation sense |
| 29) | Extension with bolts to fasten the 2 halves of the End-Cam |
| | together. |
| 30) | Crank web outline |

FIGS. 2-a and 2-b the first configuration of the hydraulic-mechanical VCR, seen normal to the rod journal axis, presents the piston at TDC position (2-a) and the piston lifted up by VCR action (2-b) after the crank rotates 9 degrees. The list of parts are:
1) VCR lift (L_{vcr})
2) Conrod small eye
3) Oil passage
4) Conrod
6) Scissor jack (behind conrod guide)
7) Back of hydraulic jack
8) Hydraulic jack piston, ram and link axis (inside the housing)
9) Conrod guide
10) Rise plungers under action by End-Cam
16) End-Cam short cylinder
17) End-Cam hydraulic actuator vane and spring
18) Rod journal outline
21) Main journal outline
26) End-cam parts
27) a&b Plungers/rollers linear rails
31) Very narrow slit at the end of the linear rail, (optional for rise plunger)
32) Plunger's roller
33) Roller's axis and guide
34) Very narrow slit at the end of the linear rail of return plunger
35) Conrod oil opening
36) Oil passage to hydraulic vanes

FIGS. 3-a/b presents the two halves of the End-Cam (3-a) joined together by bolts through the vanes and extensions, while (3-b) simplifies the roles and ranges of various parts of the End-Cam.

FIGS. 4-a/b shows the parts and dimensions of the scissor jack (4-a), while (4-b) presents the variation of pressures within the clearance volume P_{VCR} and along HJ stroke (ram) P_{H} versus hydraulic jack stroke J_{S} from TDC to VCR action.

FIG. 5 exemplifies the combined End-Cam with Face-Cam. The Face-Cam is not necessarily be directly around the End-Cam. The Face-Cam drives an extension-roller of the central pivot of the scissor jack.

FIG. 6 presents the second configuration of the hydraulic-mechanical VCR with the swash plate between the crank web and the conrod. Details are very common and similar to first configuration. The list of parts are:
18) Rod journal outline
21) Main journal outline
37) Swash plate
38) Ball joint
39) Bearings for swash plates
40) Swash plate central pivot and guide
41) Swash plate rail (part of the rod journal)
42) Locking nut for swash plates
43) Swash plate axis with crank web
44) Swash plate actuator link

### DETAILED DESCRIPTION OF THE SEVERAL EMBODIMENTS

The presented invention has two configurations based on same principle, End-Cam with plunger-follower of a hydraulic cylinder pump (HCP) and a hydraulic jack (HJ) with mechanical linkage between conrod big eye and engine piston.

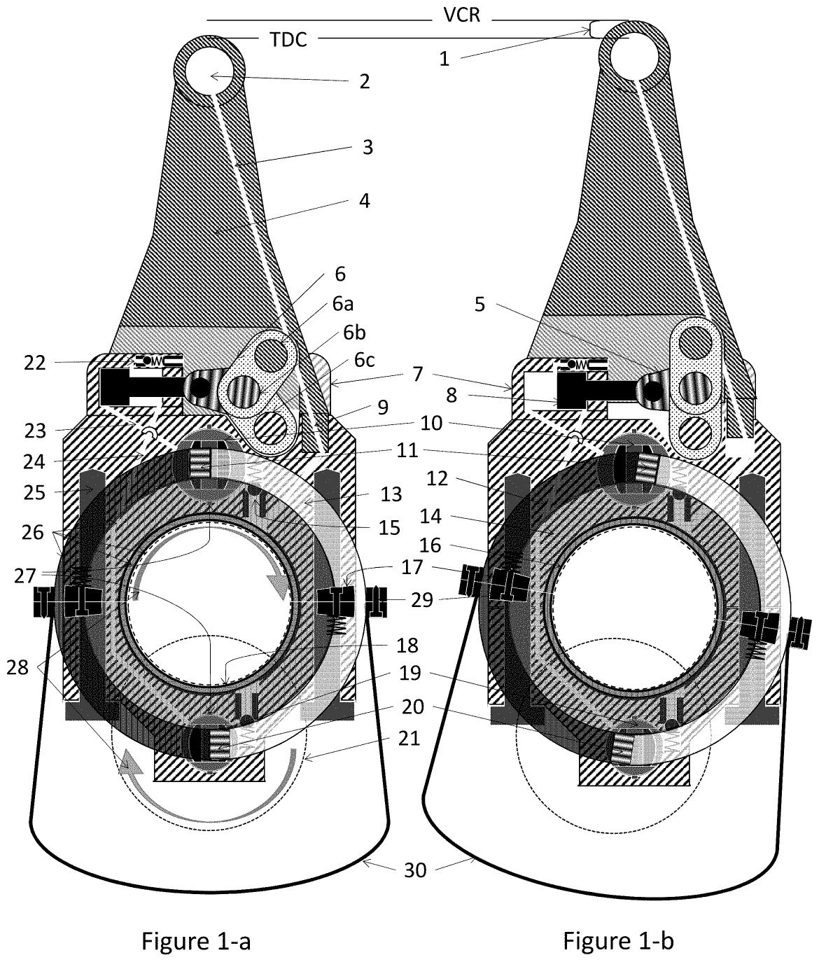

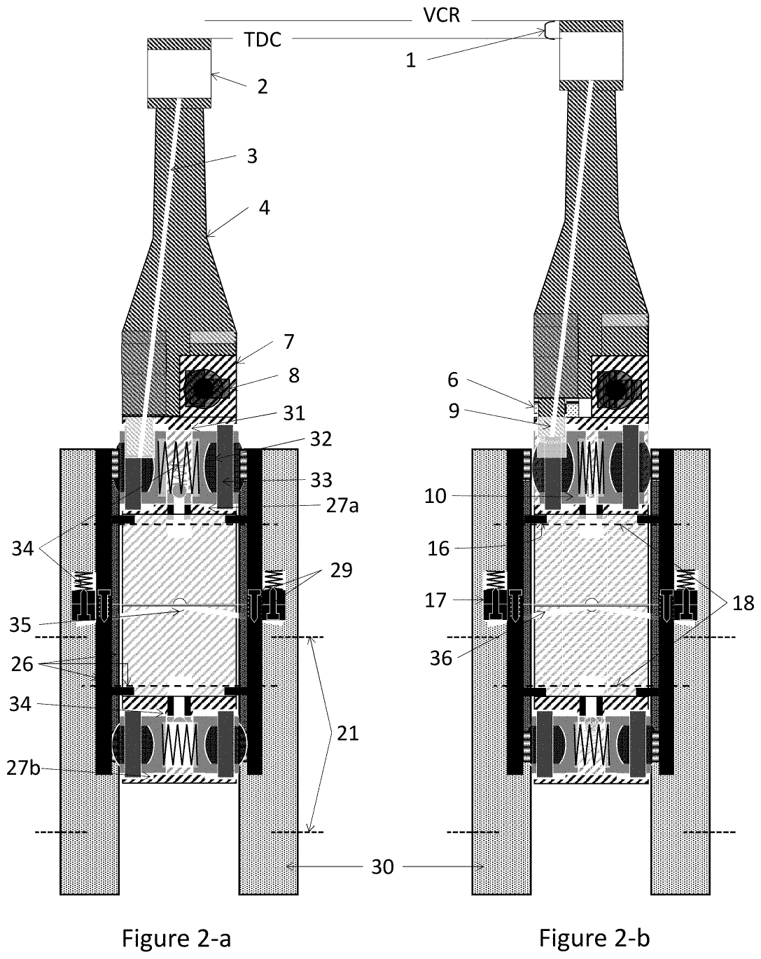

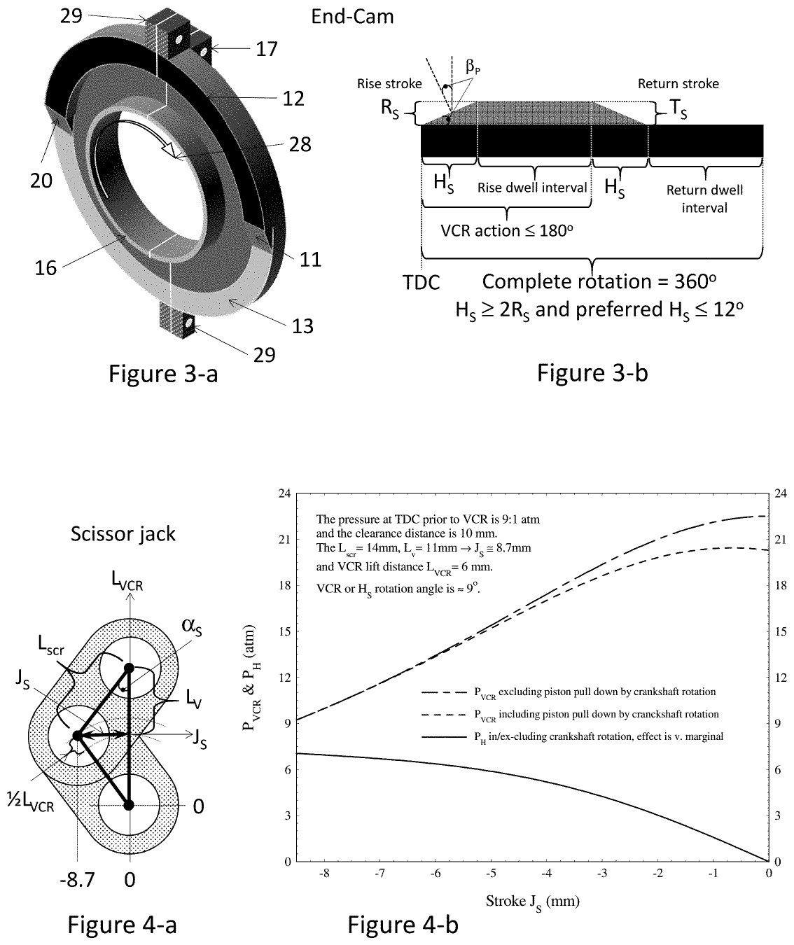

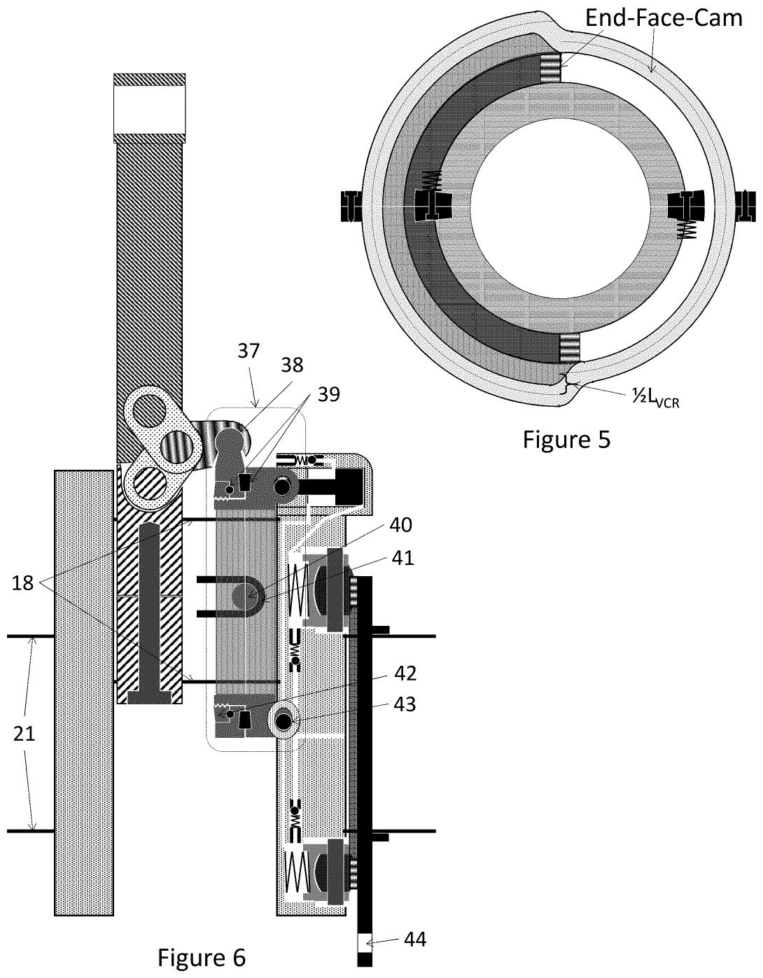

The first configuration is presented by FIGS. 1a/b and 2a/b. The whole VCR mechanism is located from rod journal to engine piston while the End-Cam, in the crankshaft web, is centered on the rod journal facing the conrod big eye. This configuration is simple and easy to implement with minimum space and has a mirror image (symmetry) about the central plane normal to rod journal which eliminates side loads when VCR is in action. The hydraulic jack, scissor jack and conrod guide have a mirror image on the back half of the conrod. Some minor details are not shown, as these are common, such as the seals of the hydraulic pistons and plungers, the seal for the oil passage between the two bearing parts of the conrod big eye and the external rings or clips for the scissor jack.

The End-Cam (FIGS. 3-a/b) in fixed case is part of the extended web and machined centered around the rod journal. The start of the cam rise stroke coincide with the TDC of the engine piston and the rise dwell interval extends to the return HCP which is 180 degrees. The horizontal stroke distance (H_{S}) of the rise stroke (R_{S}) is customizable, though recommended to be at least twice the rise stroke (H_{S}=2R_{S}) that makes the pressure angle [β_{P}=tan⁻¹(R_{S}/H_{S})=tan⁻¹(½)=26.6° ] below allowed maximum pressure angle of 30 degrees. This can be reduced further by increasing/decreasing the areas of the hydraulic cylinders/jacks, respectively, which reduces the rise stroke distance (R_{S}) of the End-Cam. Optionally, the End-Cam can also act as a Face-Cam where a groove is added around the End-Cam profile (FIG. 5). An extension of the middle pivot of the scissor jack link follows the groove. This groove is of two concentric semi-circles facing each other and differ in radii by half the VCR lift (½L_{VCR}). The rise and return between the two semi-circles match the rise, at TDC, and return of the HCPs. The advantage of the groove rise acts as an assistance to the hydraulic rise cylinder while the groove return eliminates the need for the hydraulic return cylinder. This Face-Cam may be used solely as a VCR mechanism without the hydraulic system. The disadvantage is adding more friction and more space to the VCR mechanical system.

A further improvement is achieved using variable rotating End-Cam (VREC) linked to mechanical or hydraulic actuator, similar to variable valve timing (VVT), to advance VCR action at high rpm. The simplest mechanism for the first configuration is a hydraulic vane actuator, embedded within the crankshaft web, with pressure balance spring and computer controlled electric relay valves (note FIGS. 1, 2 and 3). At high rpm's the high oil pressure from the engine oiling pump pushes the vanes of the VREC and rotates it in opposite direction to the crankshaft rotation hence advances VCR action. At low rpm's the pressure of the engine oiling pump drops and the pressure balance spring of the hydraulic actuator returns the VCR action to normal or, technically, delays VCR action. Alternatively, a mechanical actuator can be used and driven by electric motor or electromechanical devices. The result is controlled variable compression ratio timing (CVCRT).

The rise and return hydraulic cylinder pumps are housed around the big eye of the conrod, while the VCR hydraulic jack (VCR-HJ) can be directly above the big eye or directly below the engine piston. The plungers-followers of the hydraulic cylinder pumps are forced by the End-Cam to pump oil into the VCR-HJ. The oil is fed into the HCPs from the engine oiling pump through a valve that is necessary to ensure oil is fully one-way pumped into the VCR-HJ and avoid pumping oil back into the engine during the rise stroke interval. There is either one 2-way VCR-HJ or two 1-way HJ; one for rise and one for return. The rise and return hydraulic cylinder pumps are preferred to be ≤180° apart, depending on space limitations. There are linear guides for the HCP's pistons to avoid the rotation of the plunger's rollers and maintain the track of the End-Cam. The top linear rails of the linear guides are long enough to form a very narrow slits directly behind the plungers' (piston seals) when they are fully apart. These slits are important to vent air while filling the HCP's with oil and to expel oil through the return HCP when the rise dwell interval is less than 180°. However, the slits are optional for rise HCP to ensure short rise plunger stroke. Note the HCP's can be anywhere around the conrod big eye, namely the rise HCP can be directly below the HJ. The present FIGS. 1a/b and 2a/b shows the HCP's in places for clarity. The HJ piston length is equal to its stroke length and there is a small orifice with valve at the end of the stroke to vent air and to expel excess oil pumped by the HCPs (FIG. 1). This is important where the volume of oil pumped by HCP must be bigger than the volume of HJ allowing for oil circulation and refreshing and the expelled oil is directed to lubricate movable parts of the HJ. Also, to prevent oil draining backward through the HCP's slits. There are many mechanical linkages between VCR-HJ and the engine piston where the simplest is a direct HJ to lift the engine piston, which is not recommended for the fact that it diverts the high pressure above engine piston to the HCPs and exposes the End-Cam to high pressure load during the whole VCR action. Eccentric pin or crank are other choices. Each type of linkages has advantages and disadvantages. However, the best mechanical linkage is a scissor jack.

The ideal VCR linkage is a scissor jack that takes a little more space and more moving parts, though a minor disadvantage. It can be mounted with the HJ under the engine piston or above the conrod big eye. The scissor jack stroke is longer than crank linkage but subject to less pressure (see FIG. 4-b). The VCR-HJ is mounted horizontally, either one 2-way HJ or two separated 1-rise and 1-return HJ's. The middle pivot of the scissor jack is linked to the VCR-HJ. Referring to FIGS. 4-a/b, the horizontal HJ stroke J_{S} is determined by the scissor jack arm length L_{scr} and the vertical distance L_{V} i.e. J_{S}=\sqrt{L_{scr}²−L_{V}²}. The required VCR lift (L_{VCR}) distance L_{VCR} determines L_{V} where L_{VCR}=2(L_{scr}−L_{V}). The major advantage of the scissor jack is that the, horizontal, pressure P_{H} acting on the VCR-HJ along J_{S} is less than the actual, vertical, pressure P_{VCR} acting on the engine piston along L_{V}. It is determined depending on the tangent of angle αₛ (opposite to S_{H}) between L_{scr} and L_{V} such that P_{H}=P_{V}×tan(αₛ). While VCR is in action, the stroke J_{S} decrease so is angle αₛ and tan(αₛ) the clearance volume pressure P_{VC}R increases but the, horizontal, pressure P_{H} decreases to zero when the scissor jack straighten i.e. L_{V}≈L_{scr}. This is very important as it reduces load on the End-Cam and plunger-followers and allows for higher compression ratios. FIG. 4-b illustrates the variation of the P_{VCR} and P_{H} versus J_{S} with and without the effect of crankshaft pulling-down the piston. Note the use of pressure instead of force since areas are not determined. The fact that pressure=force/area meaning pressure is force per unit area allows using it instead of net force to give a good and clear idea for the behavior of forces per unit areas.

In this first configuration the rod journal and the fixed or actuated End-Cam rotates with the crankshaft about the conrod big eye while the HCP and HJ oscillate with the conrod. At TDC the very short rotation engagement, less than 10 degrees, of the HCP plunger-follower with the rise stroke of the End-Cam starts pumping oil to the HJ. The scissor linkage then if forced by HJ to straighten, results in driving/pushing up the engine piston twice the distance determined by the difference between the scissor arm length (hypotenuse) L_{scr} and the vertical distance L_{V}. Both L_{scr} and L_{V} subtended by angle αₛ and forming with the HJ horizontal stroke J_{S} (opposite to αₛ) the right-angle triangle (see FIG. 4-a). As the engine piston is driven up by the straightened scissor jack the TDC position shifts up towards the head cylinder and reduces the clearance volume leading to higher pressure and self-ignition of the air fuel mixture. This VCR mechanism is applicable to both petrol and diesel fuels.

The second configuration is limited to FIG. 6 where the hydraulic cylinder pumps (HCPs) and hydraulic jack (HJ) are part of the crankshaft web. The HCP can be anywhere around the main journal even in the counter balance web. There could be one or two rise HJ's, specifically one along the center of the rod journal and one at the top, outside the rod journal. The variable rotating End-Cam around the main journal facing the web is actuated easily mechanically or hydraulically. The scissor jack is directly above the conrod big eye. This configuration requires a swash plate to link between the hydraulic jack and the scissor jack. This second configuration occupies more space, has no symmetry in small engines which add side pressure load on the crankshaft. However, it is more practical with more space for large HCP and more space for the scissor jack. It offers more choices of actuators for the End-Cam. It removes load from the conrod to more rigid crankshaft. Details of parts and operation is same as the first configuration, except for addition of the swash plate. Here the crankshaft rotates with the hydraulic cylinder pumps and the hydraulic jack and the End-Cam is fixed to engine body, unless actuated.

It is understood that the enclosed figures relating and describing the invention, the invention is not limited to the particular figures shown and described herein. The invention is customizable in many ways that various changes and modifications may be made without departing from the scope or spirit of this invention as defined by the following claims.

What is claimed is:

1. A variable compression ratio mechanism of a reciprocating internal combustion engine, comprising:
a rise and return hydraulic cylinder pumps with plungers follow an End-Cam and a hydraulic jack;
a fixed or actuated End-Cam with/without outer groove leading to composite End-Face-Cam;
a customized mechanical linkage to hydraulic jack with preference of scissor jack type; and
a Face-Cam with two concentric semi-circle grooves as an additional or sole mechanical VCR driving the mechanical, scissor, linkage.
